(19) United States
(12) Patent Application Publication
(10) Pub. No.: US 2018/0115542 A1
(43) Pub. Date: Apr. 26, 2018

(54) SECURITY MECHANISM FOR MULTI-TIERED SERVER-IMPLEMENTED APPLICATIONS

(71) Applicant: CARADIGM USA LLC, Bellevue, WA (US)

(72) Inventors: Marcel van den Dungen, Redmond, WA (US); Mahesh K. Venkataramani, Bothell, WA (US)

(21) Appl. No.: 15/385,695

(22) Filed: Dec. 20, 2016

Related U.S. Application Data
(60) Provisional application No. 62/412,183, filed on Oct. 24, 2016.

(51) Int. Cl. H04L 29/06

(52) U.S. Cl. CPC H04L 63/083; H04L 63/0421; H04L 63/0846

(57) ABSTRACT

A facility providing securely for a multi-tiered server-implemented application is described. The facility receives in a back-end application service a request from a front-end application service. The request includes both (1) a first security token obtained by a client that called the front-end application service, which identifies as its audience the front-end application service, and (2) a second security token obtained by the front-end service identifying the back-end service as its audience. The facility validates the first and second security tokens. Where the first and second security tokens are both successfully validated, the facility performs the received request in the back-end application service. Where the first and second security tokens are not both successfully validated, the facility returns an error.

### CROSS-REFERENCE TO RELATED APPLICATION(S)

This application claims the benefit of U.S. Provisional Patent Application No. 62/412,183, filed on Oct. 24, 2016, which is hereby incorporated by reference in its entirety. Where the present application and the application incorporated by reference are inconsistent, the present application controls.

### BACKGROUND

In a two-tiered server-implemented application, a client calls a first service executing on a server, which in turn calls a second service. The first service is sometimes called a “front-end service” or “FE service,” while the second service is sometimes called a “back-end service” or “BE service.” Together, these two services perform the request represented by the client call. In some cases, the invocation of these services is protected with a security token, such as a JSON Web Token, or “JWT.”

FIG. 1 is a calling diagram showing a conventional approach to protecting access to a two-tiered server-implemented application. A browser 101 running on a client machine sends an anonymous request 111 to a first front-end service 103 that requests client-side code for the application. When this client-side code for the application 112 is returned, it is installed and executed by the browser. This client-side code sends a request 121 for a security token to a tenant directory, together with credentials that identify the user of the application. The tenant directory stores information about which users in an organization have been approved to use the application, and the credentials they should present when seeking to use the application. When the directory receives the token request, it authenticates the user using the credentials, and, if the user is entitled to use the application, it returns a security token 122, “JWT1.” The security token includes an “audience” field identifying the application, in this way indicating that the bearer of the token is entitled to use any part of the application. The token further contains an expiration field specifying a date and time when the token expires. The token is also crypto-graphically signed as a basis for detecting its subsequent modification. The client then sends a request 131 enclosing the token to a second front-end service 104. The second front-end service evaluates the security token to determine whether it is valid; that is, whether it (1) identifies the application in its audience field, (2) is unexpired, and (3) is unmodified. If all three of these tests are satisfied, then the front-end service does a certain amount of processing of the request, and determines that it needs the assistance of the back-end service 105 to finish processing the request. Accordingly, the front-end service sends a request 151 for this assistance to the back-end service, including the security token. The back-end service also evaluates whether the security token (1) identifies the application in its audience field, (2) is unexpired, and (3) is unmodified. If so, it does the processing requested by the front-end service, and returns a result 152 to the front-end service. The front-end service in turn returns a result 132 to the client.

### BRIEF DESCRIPTION OF THE DRAWINGS

FIG. 1 is a calling diagram showing a conventional approach to protecting access to a two-tiered server-implemented application.

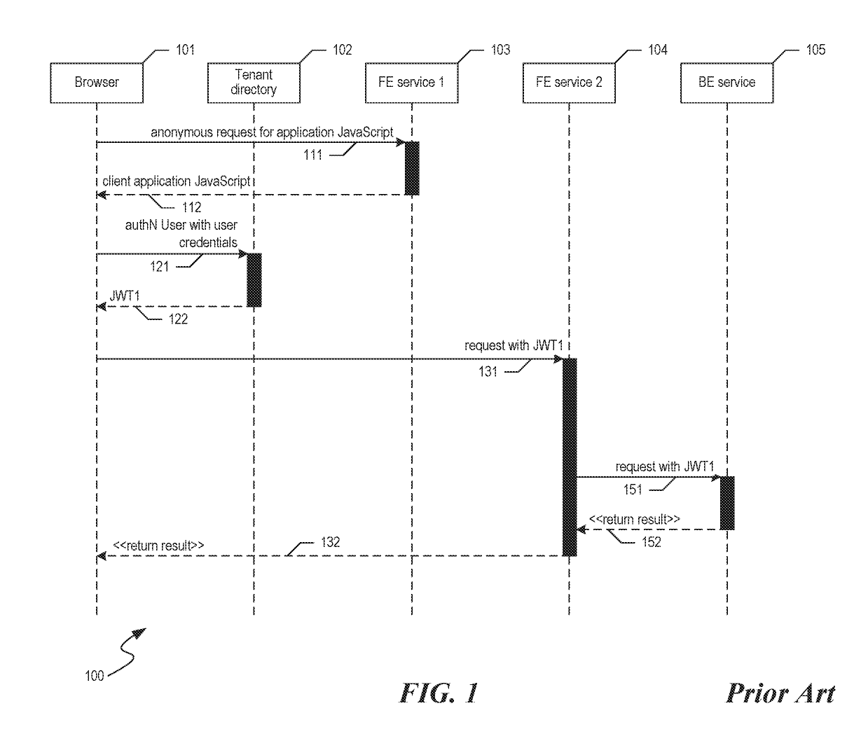

FIG. 2 is a network diagram showing a sample environment in which the facility operates in some embodiments.

FIG. 3 is a block diagram showing some of the components typically incorporated in at least some of the computer systems and other devices on which the facility operates.

FIG. 4 is a calling diagram showing a calling pattern used by the facility in some embodiments in the first approach.

FIG. 5 is a flow diagram showing a process performed by the facility in some embodiments in the first approach in the front-end service.

FIG. 6 is a flow diagram showing a process performed by the facility in some embodiments in the first approach in the back-end service.

FIG. 7 is a calling diagram showing a calling pattern used by the facility in some embodiments in the second approach.

FIG. 8 is a flow diagram showing a process performed by the facility in some embodiments in the second approach in the front-end service.

FIG. 9 is a flow diagram showing a process performed by the facility in some embodiments in the second approach in the worker service.

FIG. 10 is a flow diagram showing a process performed by the facility in some embodiments in the second approach in the back-end service.

### DETAILED DESCRIPTION

The inventors have recognized that conventional approaches to multi-tiered server-implemented application security such as the one described above have significant disadvantages. One disadvantage is that, once the client receives the single token for the entire application, it has all the credentials it needs to directly call the back-end service, bypassing any controls on access to the back-end service that would have been imposed by instead calling the front-end service. Further, because the single application token is a bearer token, once it is received by the client machine, it can be stolen from the client machine by an unauthorized user, or can be provided voluntarily to an unauthorized user by the user of the client machine. In the hands of the unauthorized user, the single application token can be used by the unauthorized user to directly call the back-end service, enabling the unauthorized user to cause the back-end service to perform any action and provide any data available to the front-end service.

In response to recognizing the foregoing disadvantages, the inventors have conceived and reduced to practice a software and/or hardware facility providing a security mechanism for multi-tiered server-implemented applications (“the facility”).

In some embodiments, the facility attributes security credentials to the front-end service called by the client. When the front-end service is called by the client with a first token denoting the user's entitlement to use the application (“user token”), the front-end service uses its own credentials to request a second token for accessing the back-end service (“service token”). When the front-end service receives the service token, the front-end service sends a request to the back-end service including both the application token and the service token. The back-end service services the front-end service's request—such as by reading, writing, updating, deleting, and/or analyzing data to which it has access—only if (1) both of the tokens are unmodified and unexpired, and (2) they identify the front-end service and the back-end service as their audiences, respectively.

In some embodiments, the facility is adapted to operate more effectively in connection with a multi-tiered server-implemented application in which an asynchronous queueing mechanism is used to process requests sent by a front-end service to a back-end service. In such embodiments, when the front-end service receives a request from the client with the user token, it places a request against the back-end service in a queue or service bus that encloses the user token. A worker service retrieves the request from the queue or service bus; uses its own credentials to obtain a service token; and submits a request to the back-end server with the user and service tokens. In the back-end service, the facility determines whether the service token is unexpired, unmodified, and identifies the back-end device as its audience. It also determines whether the user token is unmodified and identifies the back-end service as its audience, but does not test whether it is expired, as such expiration could have occurred during the time that the request waited on the server bus. The back-end service only processes the request if these tests are satisfied.

By performing some or all of the ways described above, the facility makes it more difficult for a back-end service to be accessed by or on behalf of an unauthorized user.

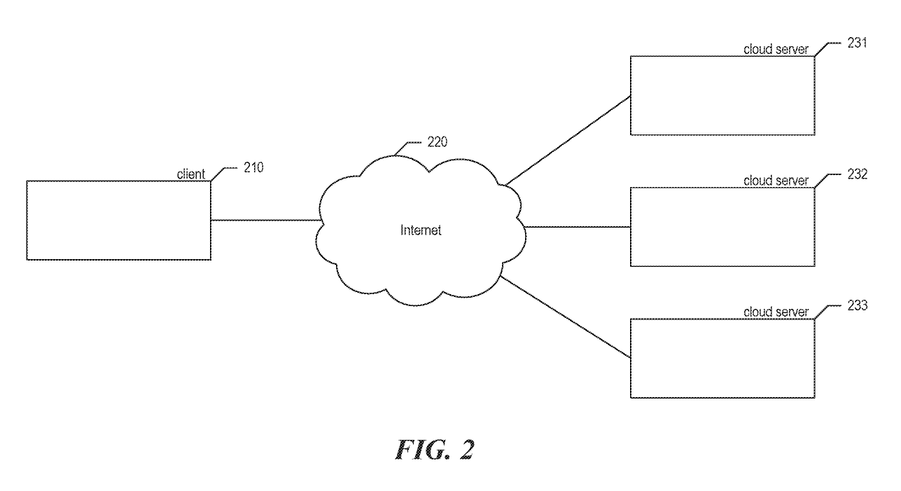

FIG. 2 is a network diagram showing a sample environment in which the facility operates in some embodiments. In this environment, a client 210 makes requests of front-end services executing on server devices, such as cloud servers 231-233. Such requests and their responses are transmitted via the Internet 220 or another network. The front-end service executing on the servers makes requests of its own, such as against the following, running on the same or different servers: back-end services, service buses and worker services, application directories, etc. The servers may be physical or virtual servers, and may, for example, be owned or rented by the operator of the facility, the operator of the application, or other parties.

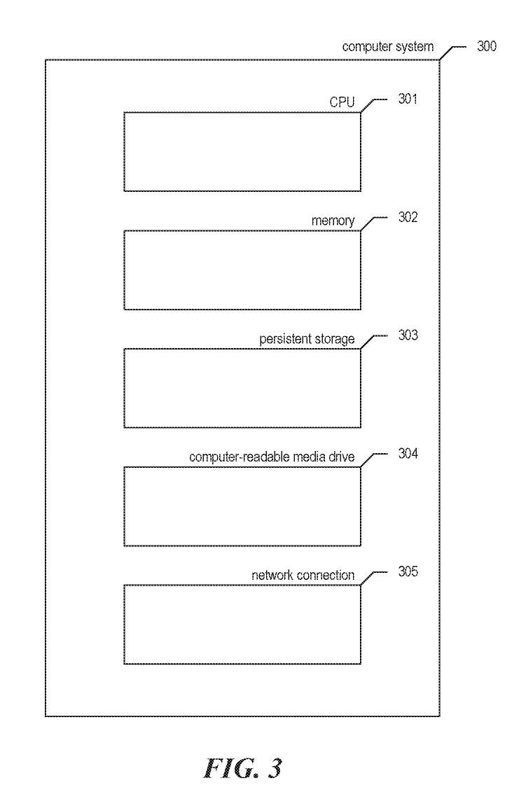

FIG. 3 is a block diagram showing some of the components typically incorporated in at least some of the computer systems and other devices on which the facility operates. In various embodiments, these computer systems and other devices 300 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”) 301 for executing computer programs; a computer memory 302 for storing programs and data while they are being used, including the facility and associated data, an operating system including a kernel, and device drivers; a persistent storage device 303, such as a hard drive or flash drive for persistently storing programs and data; a computer-readable media drive 304, such as a floppy, CD-ROM, or DVD drive, for reading programs and data stored on a computer-readable medium; and a network connection 305 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

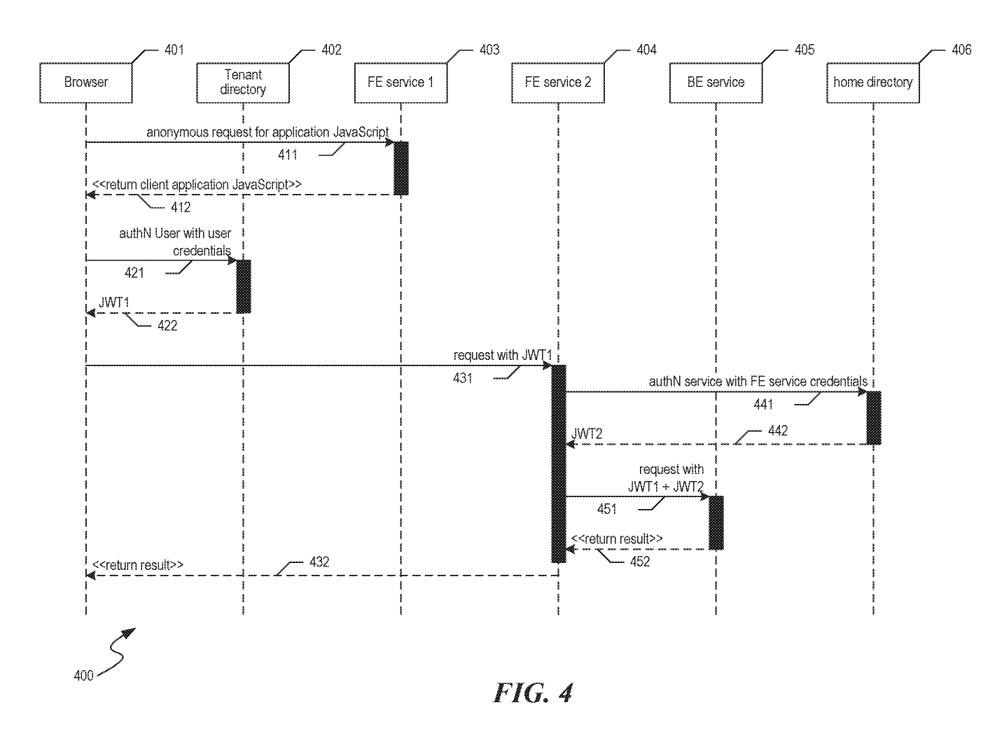

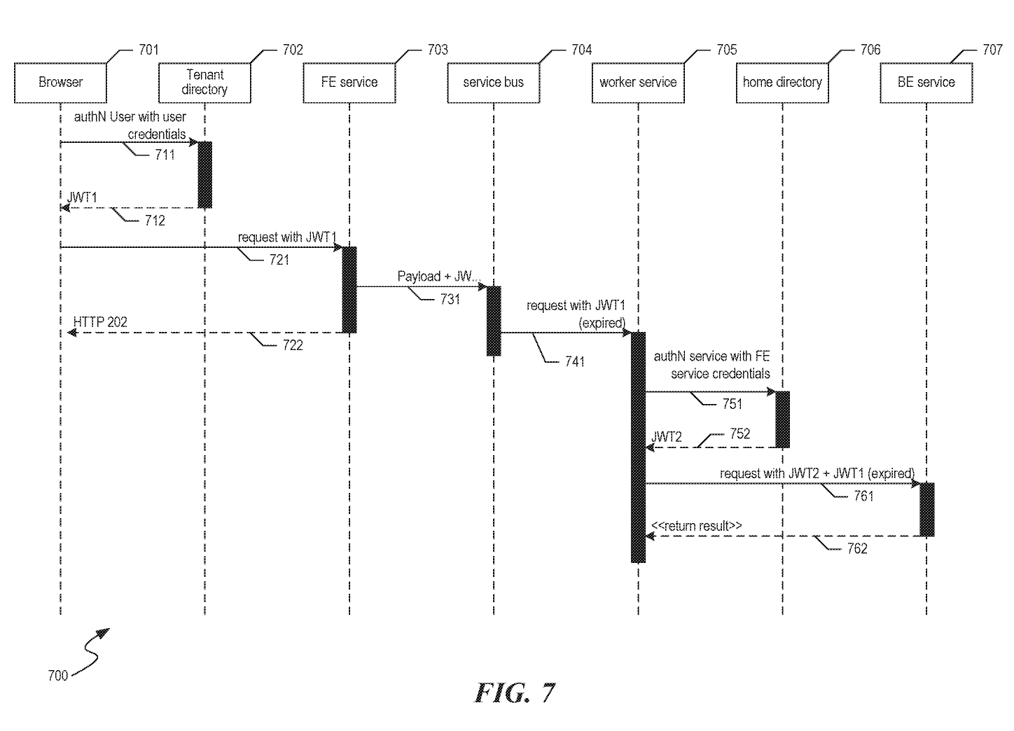

The facility is discussed below in terms of both a first approach in which front-end services call back-end services synchronously, and a second approach in which front-end services call back-end services asynchronously, such as through a queue or service bus. FIGS. 4-6 are directed to the first approach, while FIGS. 7-10 are directed to the second approach.

FIG. 4 is a calling diagram showing a calling pattern used by the facility in some embodiments in the first approach. The browser 401 executing on the client sends an anonymous request 411 for client-side application code to a first front-end server 403. The first front-end server responds by returning the client-side application code, such as JavaScript executable by the browser. The client-side code sends a security token request 421 to a tenant directory service 402. Token request 421 contains information identifying the user of the client and confirming that identity, and information identifying the front-end service as the requested audience for the security token to be produced. In some embodiments, the tenant directory service is implemented as a Microsoft Active Directory, such as a Microsoft Azure Active Directory. If the credentials included in the request successfully authenticate the user, and the user is entitled to use the application, then the tenant directory sends the client a reply 422 containing a user token (“JWT1”) for using the application. In some embodiments, the token is a JSON Web Token, or “JWT.” JWTs, their creation, and their use are discussed in Internet Engineering Task Force Request for Comments 7519, referred to as International Standard Serial Number 2070-1721, available from tools.ietf.org/html/rfc7519, which is hereby incorporated by reference in its entirety. The client application code uses this “user token” to call a second front-end service 404 with an application request 431.

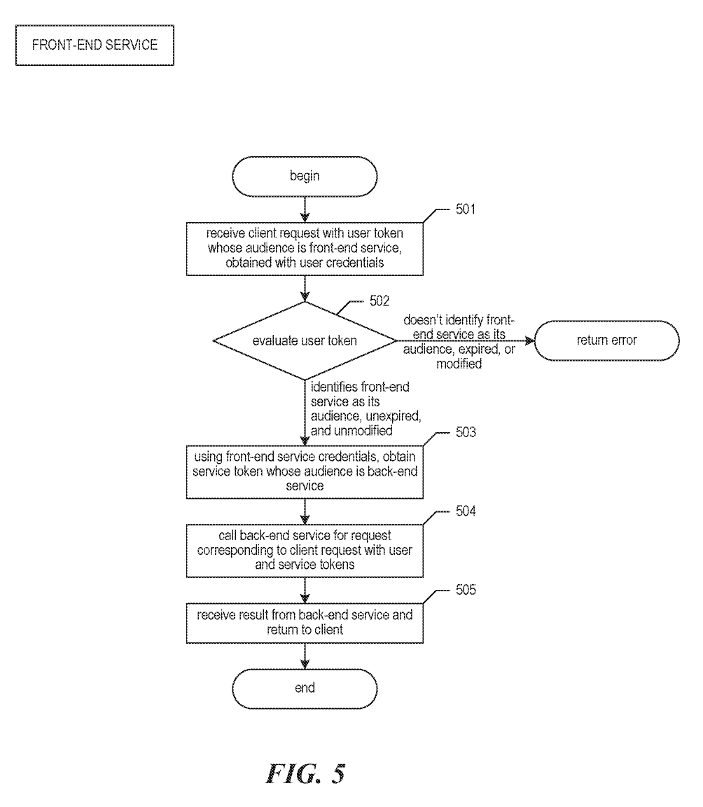

FIG. 5 is a flow diagram showing a process performed by the facility in some embodiments in the first approach in the front-end service. In act 501, the facility receives the client request 431 containing the user token. In act 502, the facility evaluates the application token; if it is unmodified and unexpired, and identifies the front-end service in its audience field, the facility continues in act 503, else the facility returns an error. In act 503, the facility uses credentials of the front-end service to obtain a second, “service token” token whose audience is the back-end service.

Returning to FIG. 4, the facility sends token request 441 from the front-end service for 404 to a home directory 406. The token request contains credentials of the front-end service 404, and identifies the back-end service as the audience for which a token is to be created. If the front-end service's identity can be authenticated using the credentials and the front-end service is entitled to access the back-end service, the home directory replies with a service bearer token (“JWT2”) that can be used to access the back-end service.

Returning to FIG. 5, in act 504, the facility calls the back-end service for a request 451 that corresponds to the client request 431, including both the user token and the service token.

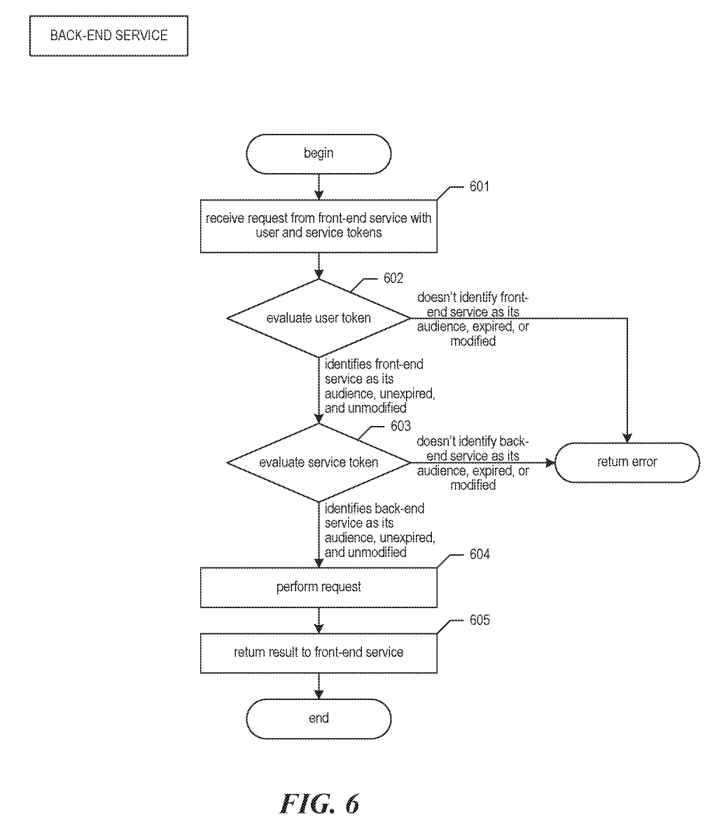

FIG. 6 is a flow diagram showing a process performed by the facility in some embodiments in the first approach in the back-end service. In act 601, the facility receives request 451 from the front-end service with a user token and a service token.

Table 1 below shows a sample request from the front-end service that contains user and service security tokens. Line 6 shows where the content of the user token is included in the request, while line 4 shows where the service token is included.

TABLE 1

| | |
|---|---|
| 1 | GET http://localhost:28591/api/values HTTP/1.1 |
| 2 | Accept: application/json |
| 3 | Authorization: bearer |
| 4 | <JWT2> |
| 5 | UserToken: |
| 6 | <JWT1> |
| 7 | Host: localhost:28591 |
| 8 | Connection: Keep-Alive |

In act 602, the facility evaluates the user token; if the user token identifies the front-end service as its audience and is unmodified and unexpired, then the facility continues in act 603, else the facility returns an error. In act 603, the facility evaluates the service token; if it identifies the back-end service as its audience and is unmodified and unexpired, then the facility continues in steps 604, else the facility returns an error. In some embodiments (not shown), the facility performs step 603 before step 602. In act 604, the facility performs the request on behalf of the front-end service, such as by modifying, deleting, analyzing, and/or retrieving data, such as data relating to patients and their medical treatment. In act 605, the facility returns a result 452 from the back-end service to the front-end service. After act 605, these steps conclude.

Those skilled in the art will appreciate that the acts shown in FIG. 6 and in each of the other flow diagrams discussed herein may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

Returning to FIG. 5, in act 505, the facility receives the result sent by the back-end service and returns the result 432 to the client.

FIGS. 7-10 relate to the second approach performed by the facility in some embodiments in which front-end services call back-end services asynchronously, such as through a queue or service bus.

FIG. 7 is a calling diagram showing a calling pattern used by the facility in some embodiments in the second approach. Client-side application code running on the client, such as browser 701, sends a tenant directory 702 a request 711 for an application token; the request contains credentials of the client's user. Upon authenticating the user credentials and verifying that the user is entitled to access the application, it returns user token 712, which entitles the user to access the application. The client-side application code sends a request 721 to a front-end service 703, enclosing the user token.

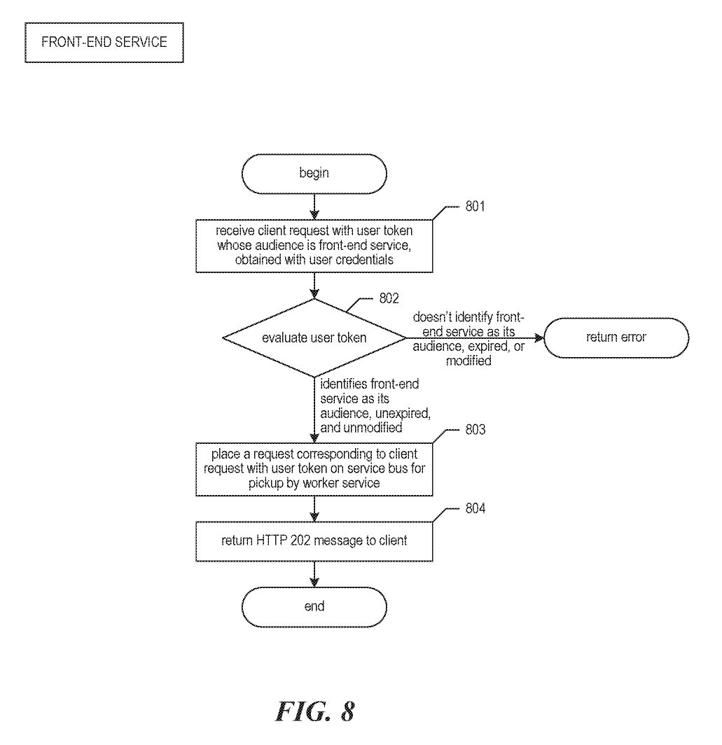

FIG. 8 is a flow diagram showing a process performed by the facility in some embodiments in the second approach in the front-end service. In act 801, the facility receives the client request 721 in the front-end service. In act 802, the facility evaluates the user token received in the client request; if it identifies the front-end service in its audience field, and is unmodified and unexpired, then the facility continues in act 803, else the facility returns an error. In act 803, the facility places a request 731 corresponding to the client request that also contains the user token on a service bus 704 for pickup by a worker service 705 for further processing. In act 804, the facility returns an HTTP 202 message 722 to the client, indicating that the client request has been queued. In some embodiments, the HTTP 202 message includes information usable by the client to check on the status of the performance of the queued request. After act 804, this process concludes.

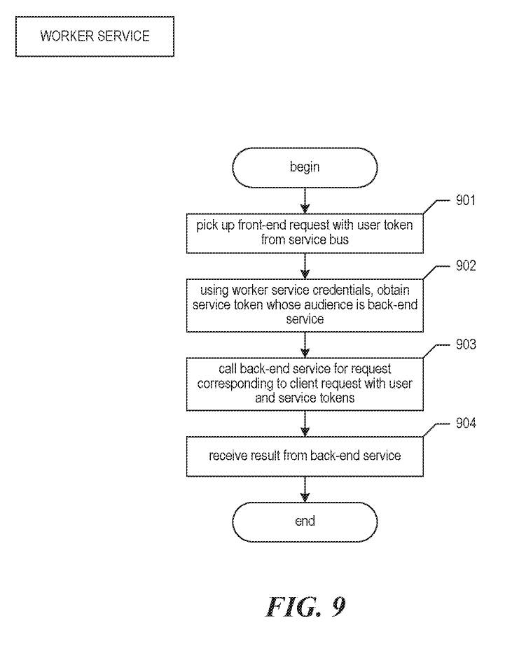

FIG. 9 is a flow diagram showing a process performed by the facility in some embodiments in the second approach in the worker service. In act 901, the facility picks up from the service bus the request 741 from the front-end containing the user token. In act 902, using credentials of the worker service, the facility obtains a service token whose audience is the back-end service. This involves sending a token request 751 to a home directory 706, and receiving the requested service token 752 in response. In act 903, the facility calls the back-end service for a request 451 that corresponds to the client request 431, including both of the user token and the service token.

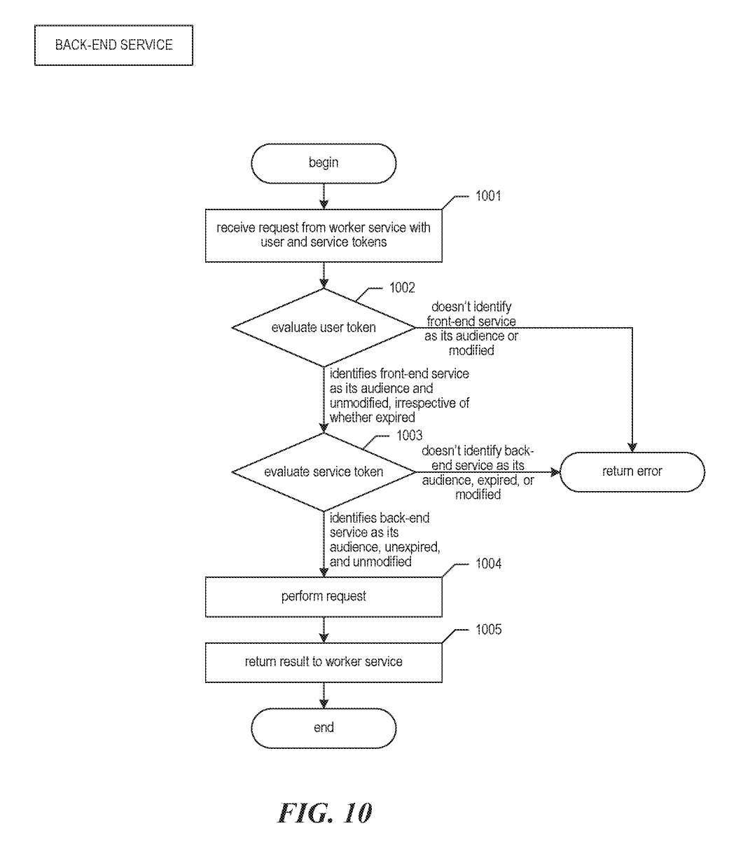

FIG. 10 is a flow diagram showing a process performed by the facility in some embodiments in the second approach in the back-end service. In act 1001, the facility receives request 761 from a worker service, which contains user and service tokens, such as a user token contained in a “UserToken” header as shown in row 5 of Table 1 and a service token contained in an “Authorization header as shown in row 3 of Table 1. In act 1002, the facility evaluates the user token; if it has the application as its audience and is unmodified—irrespective of whether or not it is expired, then the facility continues in 1003, else the facility returns an error. In act 1003, the facility evaluates the service token; if it has as its audience the back-end service and is unmodified and unexpired, then the facility continues in act 1004, else the facility returns an error. In act 1004, the facility performs the received request. In act 1005, the facility returns the result 762 of performing the request to the worker service. After act 1005, this process concludes.

Returning to FIG. 9, in act 904, the facility receives the result 762 from the back-end service. After act 904, these steps conclude. At this point, the worker service has completed its processing of the front-end request picked up in act 901, and it can proceed to pick up another front-end request from the service bus for processing.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

We claim:

1. A method in the computing system, comprising:
receiving in a back-end application service a request from a front-end application service, the request including both (1) a first security token obtained by a client that called the front-end application service, the first security token identifying as its audience the front-end application service, and (2) a second security token obtained by the front-end service identifying the back-end service as its audience;
validating the first and second security tokens;
where the first and second security tokens are both successfully validated, performing the received request in the back-end application service; and
where the first and second security tokens are not both successfully validated, returning an error.

2. The method of claim 1 wherein successfully validating the first security token comprises determining that (1) its audience is the front-end service application service, (2) it is unmodified since creation, and (3) it is unexpired, and wherein successfully validating the second security token comprises determining that (1) its audience is the back-end application service, (2) it is unmodified since creation, and (3) it is unexpired.

3. The method of claim 1 wherein successfully validating the second security token comprises determining that (1) its audience is the front-end application service, (2) it is unmodified since creation, and (3) it is unexpired,
and wherein successfully validating the first security token comprises determining that (1) its audience is the back-end application service, and (2) it is unmodified since creation, irrespective of whether it is expired or unexpired.

4. The method of claim 1 wherein the first and second security tokens are bearer tokens.

5. The method of claim 1 wherein the first and second security tokens are JSON Web Tokens.

6. The method of claim 1 wherein performing the received request in the back-end application service comprises returning data that is based on data retrieved by the back-end application service.

7. The method of claim 1 wherein performing the received request in the back-end application service comprises storing data that is based on data received in the request.

8. One or more instances of computer-readable media having contents configured to cause a computing system to perform a method, the method comprising:
receiving in a back-end application service a request from a front-end application service, the request including both a first security token, and a second security token obtained by the front-end service identifying the back-end service as its audience;
determining that:
the first security token identifies as its audience the front-end application service,
the first security token is unmodified since creation,
the first security token is expired,
the second security token identifies as its audience the back-end application service,
the second security token is unmodified since creation, and
the second security token is unexpired;
in response to the determining, performing the received request in the back-end application service.

9. The one or more instances of computer-readable media of claim 8 wherein the first and second security tokens are bearer tokens.

10. The one or more instances of computer-readable media of claim 8 wherein the first and second security tokens are JSON Web Tokens.

11. The one or more instances of computer-readable media of claim 8 wherein performing the received request in the back-end application service comprises returning data that is based on data retrieved by the back-end application service.

12. The one or more instances of computer-readable media of claim 8 wherein performing the received request in the back-end application service comprises storing data that is based on data received in the request.

13. A networking hardware device transmitting a back-end request data structure originated by a front-end service of an application and addressed to a back-end service of the application, the requested structure comprising:
an action requested of the back-end service by the front-end service;
a first bearer security token obtained by a user of the application using credentials of the user that identifies the application as its audience; and
a second bearer security token obtained by the front-end service using credentials of the front-end service that identifies the back-end service as its audience, such that, when the data structure is received at the back-end service, its contents can be used by the back-end service to validate the first and second bearer security tokens, and to perform the requested action only if such validation is successful.
